(19) United States
(12) Patent Application Publication
(10) Pub. No.: US 2025/0111303 A1
(43) Pub. Date: Apr. 3, 2025

(54) MACHINE LEARNING PREDICTION OF WORKING HOURS FOR PICKERS OF A FULFILLMENT SERVICE

(71) Applicant: Maplebear Inc., San Francisco, CA (US)

(72) Inventors: Rucheng Xiao, Chicago, IL (US); Aoshi Li, Toronto (CA); Youdan Xu, Burlingame, CA (US); Mengyu Zhang, Chestnut Hill, MA (US); Chen Zhang, Campbell, CA (US); Ziwei Shi, San Francisco, CA (US); Matthew Donghyun Kim, Seattle, WA (US)

(21) Appl. No.: 18/374,457

(22) Filed: Sep. 28, 2023

(51) Int. Cl. G06Q 10/0631

(52) U.S. Cl. CPC G06Q 10/063114; G06Q 10/063118

(57) ABSTRACT

An online concierge system identifies a set of attributes of one or more future time periods and accesses a machine learning model trained to predict a set of working hours for a picker during a future time period, in which the set of working hours describes an availability of the picker to service orders placed with the online concierge system. The online concierge system then applies the machine learning model to the set of attributes to predict the set of working hours for the picker during the future time periods and stores the predicted set of working hours for the picker during the future time periods.

### BACKGROUND

Online concierge systems allow customers to place online delivery orders and select delivery timeframes during which the orders are to be delivered. The orders are matched with pickers who access the online concierge systems to view information describing orders available for servicing. The pickers may then accept and service the orders (e.g., by driving to retailer locations, collecting items included in the orders, and delivering the orders to customers). Pickers may provide information to online concierge systems describing their general availabilities to service orders, allowing the online concierge systems to predict various types of information. For example, based on a number of pickers who have indicated their availability to service orders during various times of the day and days of the week in a geographical region, an online concierge system may predict delivery times for orders including items to be picked up from retailer locations and delivered to delivery locations within the geographical region.

However, the availabilities of pickers to service orders may differ from that described by information provided by the pickers for various reasons, which may make it difficult for online concierge systems to make accurate predictions based on this information. For example, a picker may forget to access an online concierge system during a time at which they have indicated they are available to service orders to view information describing orders available for servicing. In the above example, another picker may not update information describing their availability with the online concierge system if their availability changes over time. Continuing with the above example, if fewer pickers are actually available to service orders than anticipated by the online concierge system, orders may be delivered late, which may negatively affect customer satisfaction.

### SUMMARY

In accordance with one or more aspects of the disclosure, an online concierge system predicts working hours for pickers of the online concierge system. More specifically, an online concierge system identifies a set of attributes of one or more future time periods and accesses a machine learning model trained to predict a set of working hours for a picker during a future time period, in which the set of working hours describes an availability of the picker to service orders placed with the online concierge system. The online concierge system then applies the machine learning model to the set of attributes to predict the set of working hours for the picker during the future time period(s) and stores the predicted set of working hours for the picker during the future time period(s).

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for predicting a set of working hours for a picker of an online concierge system, in accordance with one or more embodiments.

FIG. 4 is an example of a notification for a picker to access an online concierge system to view information describing a set of orders available for servicing, in accordance with one or more embodiments.

FIG. 5 illustrates examples of picker cohorts, in accordance with one or more embodiments.

### DETAILED DESCRIPTION

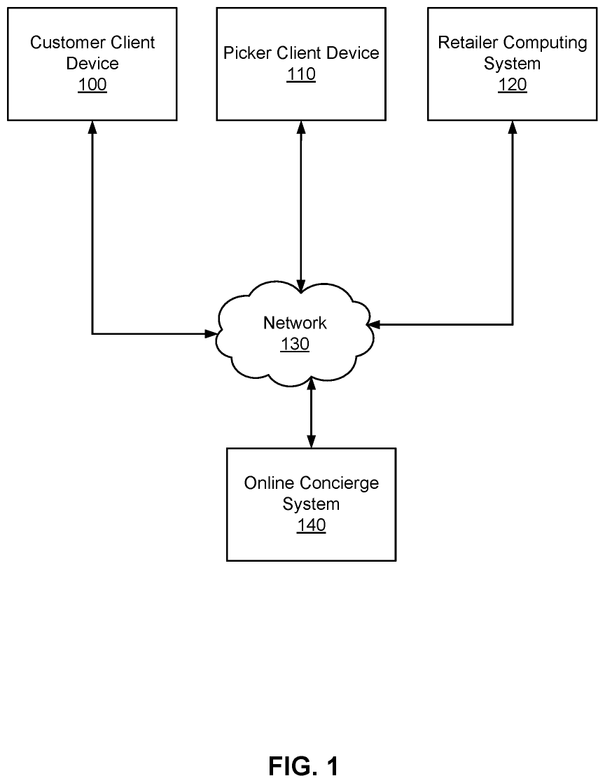

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or a desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, refers to a good or product that may be provided to the customer through the online concierge system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the customer has selected for an order but that has not yet been finalized for an order. The ordering interface allows a customer to update the shopping list, e.g., by changing the quantity of items, adding or removing items, or adding instructions for items that specify how the items should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the customer to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer location. The picker client device 110 presents the items that are included in the customer's order to the picker in a collection interface. The collection interface is a user interface that provides information to the picker identifying items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 provides instructions to a picker for delivering the items for a customer's order. For example, the picker client device 110 displays a delivery location from the order to the picker. The picker client device 110 also provides navigation instructions for the picker to travel from the retailer location to the delivery location. If a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140. Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 may provide item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a customer's order (e.g., as a commission).

The customer client device 100, the picker client device 110, the retailer computing system 120, and the online concierge system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

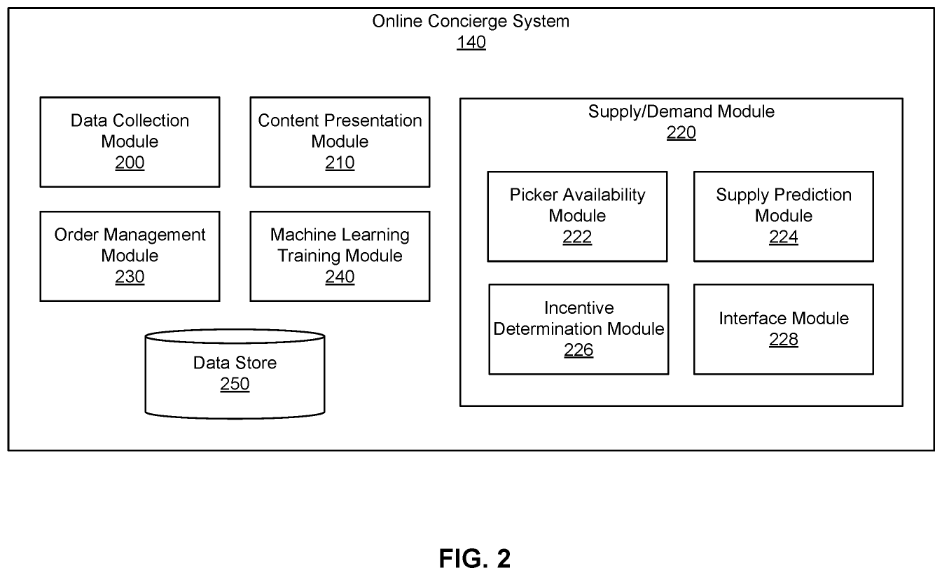

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer. As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, a supply/demand module 220, an order management module 230, a machine learning training module 240, and a data store 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 250. The data collection module 200 may only collect data describing a user if the user has previously explicitly consented to the online concierge system 140 collecting data describing the user. Additionally, the data collection module 200 may encrypt all data, including sensitive or personal data, describing users.

The data collection module 200 collects customer data, which is information or data describing characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the sizes, colors, weights, stock keeping units (SKUs), or serial numbers for the items. The item data may further include purchasing rules associated with each item, if they exist. For example, age-restricted items such as alcohol and tobacco are flagged accordingly in the item data. Item data may also include information that is useful for predicting the availability of items at retailer locations. For example, for each item-retailer combination (a particular item at a particular retailer location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or a customer client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online concierge system 140, a customer rating for the picker, the retailers from which the picker has collected items, or the picker's previous shopping history. Additionally, the picker data may include preferences expressed by a picker, such as their preferred retailers for collecting items, how far they are willing to travel to deliver items to a customer, how many items they are willing to collect at a time, timeframes within which the picker is willing to service orders, or payment information by which the picker is to be paid for servicing orders (e.g., a bank account). Preferences expressed by a picker also may describe how the picker prefers to receive notifications from the online concierge system 140. For example, a set of preferences expressed by a picker may indicate that the picker would like to receive notifications to access information about orders placed with the online concierge system 140 available for servicing as push notifications. Preferences expressed by a picker also may describe one or more geographical regions for which the picker is willing to service orders (e.g., geographical region(s) including retailer locations from which the picker is willing to collect items included in orders or delivery locations to which the picker is willing to deliver orders) during one or more time periods. In various embodiments, picker data also includes information that is derived from or predicted based on other picker data. For example, based on a picker's previous shopping history, picker data associated with the picker may include a frequency with which the picker serviced orders placed with the online concierge system 140. Additionally, picker data for a picker may describe an availability of the picker to service orders placed with the online concierge system 140 or historical working hours data associated with the picker, as further described below. The data collection module 200 collects picker data from sensors of the picker client device 110 or from the picker's interactions with the online concierge system 140 (e.g., via a client application executing on the picker client device 110 that is configured to interact with the online concierge system 140). The data collection module 200 also may collect picker data from one or more third-party systems, as described below.

An availability of a picker to service orders placed with the online concierge system 140 may be described by a set of working hours for the picker. A set of working hours for a picker includes a set of times (e.g., minutes, hours, etc.) during which the picker is available to service orders placed with the online concierge system 140. For example, an availability of a picker may indicate that the picker is available to service orders placed with the online concierge system 140 on weekdays between 7:00 a.m. and 7:45 a.m. and on weekends between 4:00 p.m. and 6:00 p.m. Information describing a set of working hours for a picker may be received from a picker client device 110 associated with the picker. Information describing a set of working hours for a picker may include a start time, an end time, or a state associated with the picker (e.g., indicating that the picker is looking for work), as further described below. In some embodiments, a set of working hours for a picker is predicted by the picker availability module 222 for one or more future time periods, as described below. In such embodiments, the predicted set of working hours is stored in association with picker data for the picker (e.g., as a schedule associated with the picker). An availability of a picker also may be associated with other types of information, such as one or more geographical regions for which the picker is willing to service orders, or any other suitable types of information. For example, a set of working hours for a picker may indicate that the picker is available to service orders placed with the online concierge system 140 on weekdays between 9:00 a.m. and 12:00 p.m. in one geographical region and on weekends between 10:00 a.m. and 2:00 p.m. in another geographical region.

Historical working hours data associated with a picker may describe one or more previous sets of working hours for the picker. A previous set of working hours for a picker includes a set of times during which the picker was available to service orders placed with the online concierge system 140, regardless of whether the picker actually serviced any orders during this set of times. Historical working hours data associated with a picker may include various types of information. For example, historical working hours data associated with a picker may include a start time or an end time associated with a previous set of working hours for a picker. In this example, the start time may be an earliest time of a day that a request to access information describing a set of orders placed with the online concierge system 140 available for servicing was received from a picker client device 110 associated with the picker, while the end time may be a latest time of the day that a request to access this information was received from the picker client device 110. As an additional example, historical working hours data for a picker may include a state of the picker associated with a previous set of working hours for the picker or a geographical region associated with a previous set of working hours for the picker. In this example, the state of the picker may indicate that the picker was looking for or available for work, working (e.g., collecting items included in an order, driving to a retailer location or a delivery location, or delivering an order), etc. rather than offline, not available for work, etc. As yet another example, historical working hours data for a picker may include a set of contextual features associated with a previous set of working hours for the picker. In this example, the set of contextual features may include weather conditions (e.g., heavy rain or snow), seasonality (e.g., a set of times of the day, days of the week, months, holidays, seasons, etc.), traffic conditions (e.g., heavy or light traffic, road closures, or detours), etc. for a geographical region for which the picker was willing to service orders. In the above example, the set of contextual features may be received from one or more third-party systems (e.g., weather, traffic, or calendar applications or websites) or any other suitable source.

Additionally, the data collection module 200 collects order data, which is information or data describing characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. In this example, the content presentation module 210 then displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order an item. In some embodiments, the item selection model uses item embeddings describing items and customer embeddings describing customers to score items. These item embeddings and customer embeddings may be generated by separate machine learning models and may be stored in the data store 250.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an item availability model to predict the availability of an item. An item availability model is a machine learning model that is trained to predict the availability of an item at a retailer location. For example, the item availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The supply/demand module 220 manages the supply of pickers to meet the demand to service orders placed with the online concierge system 140. The supply/demand module 220 may do so using various components of the supply/demand module 220. Components of the supply/demand module 220 include: a picker availability module 222, a supply prediction module 224, an incentive determination module 226, and an interface module 228, which are further described below.

The picker availability module 222 identifies a set of attributes of one or more future time periods. Attributes of a future time period may include contextual features associated with the future time period and a geographical region, such as weather conditions (e.g., heavy rain or snow), seasonality (e.g., a set of times of the day, days of the week, months, holidays, seasons, etc.), traffic conditions (e.g., heavy or light traffic, road closures, detours, etc.), or any other suitable types of contextual information. A geographical region associated with a future time period may be associated with a picker (e.g., a geographical region for which the picker is willing to service orders during the future time period). The picker availability module 222 may identify the set of attributes of the future time period(s) based on information received from one or more third-party systems (e.g., third-party weather, traffic, or calendar applications or websites), picker data associated with a picker (e.g., received from a picker client device 110 associated with the picker or retrieved from the data store 250), or any other suitable types of information. For example, based on information received from a picker client device 110 describing a time zone associated with a picker and information received from a calendar application describing a future time period corresponding to the next seven days, the picker availability module 222 may identify attributes of the future time period, including days of the week, one or more months, any holidays, etc. included in the future time period. In the above example, suppose that the picker availability module 222 retrieves information from the data store 250 describing a geographical region for which the picker is willing to service orders during the future time period and also receives information describing a weather forecast and traffic conditions for the geographical region during the future time period from one or more third-party systems (e.g., weather and traffic websites). In this example, based on the information received from the third-party system(s), attributes of the future time period identified by the picker availability module 222 also may include projected weather and traffic conditions associated with each day of the future time period for the geographical region.

The picker availability module 222 also predicts a set of working hours for a picker during one or more future time periods. The picker availability module 222 may make the prediction based on historical working hours data associated with the picker retrieved from the data store 250 or based on any other suitable types of information. For example, suppose that historical working hours data associated with a picker includes a start time and an end time associated with a previous set of working hours for the picker. In this example, if the start time and the end time are 9:00 a.m. and 5:00 p.m., respectively, for every weekday for the previous two months, based on the historical working hours data associated with the picker, the picker availability module 222 may predict a set of working hours for the picker during the next week corresponding to 9:00 a.m. to 5:00 p.m. every weekday. In some embodiments, the picker availability module 222 only predicts a start time associated with a set of working hours for a picker during one or more future time periods, which may correspond to a time at which a notification is sent to a picker client device 110 associated with the picker, as further described below. A predicted set of working hours for a picker also may be associated with a value (e.g., a score or percentage) indicating a predicted likelihood that the picker will be available to service orders placed with the online concierge system 140 during the corresponding set of hours. Once the picker availability module 222 predicts a set of working hours for a picker during one or more future time periods, information describing the predicted set of working hours may be stored in the data store 250 in association with picker data for the picker (e.g., as a schedule associated with the picker).

In some embodiments, the picker availability module 222 predicts a set of working hours for a picker during one or more future time periods using a picker availability model, which is a machine learning model trained to predict the set of working hours for the picker. For example, the picker availability model may be a linear regression model that is specific to each picker. To use the picker availability model, the picker availability module 222 may access the model (e.g., from the data store 250) and apply the model to a set of inputs, which may include a set of attributes of one or more future time periods. The picker availability module 222 then receives an output from the picker availability model describing a predicted set of working hours for a picker during the future time period(s). For example, the picker availability module 222 may provide an input to the picker availability model including a set of attributes of one or more future time periods (e.g., holidays, days of the week, projected weather or traffic conditions, etc.) and receive an output from the model describing a predicted set of working hours for a picker during the future time period(s). In this example, the predicted set of working hours may be described by a start time (e.g., 10:00 p.m. on Aug. 10, 2023) and an end time (e.g., 2:00 a.m. on Aug. 11, 2023). In embodiments in which the picker availability module 222 only predicts a start time associated with a set of working hours for a picker during one or more future time periods, as described above, the output of the picker availability model may only include the start time. The output of the picker availability model also may include additional types of information, such as a value indicating a predicted likelihood that the picker will be available to service orders placed with the online concierge system 140 during the predicted set of working hours, one or more values indicating whether there are any working hours predicted for the picker during the future time period(s), etc. For example, the output may include a value of null or 0 if there are no working hours during the future time period(s) or a value of 1 if there are at least some working hours during the future time period(s). In various embodiments, the picker availability model is trained by the machine learning training module 240, as described below.

The supply prediction module 224 may predict an incremental increase to the supply of pickers available to service orders for one or more geographical regions during one or more future time periods. The supply prediction module 224 may do so based on a predicted set of working hours for a picker and information describing a geographical region for which the picker is willing to service orders during the future time period(s). For example, suppose that a predicted set of working hours for a picker is between 4:00 p.m. and 9:00 p.m. on a particular date in the future and that a set of preferences associated with the picker indicates that the picker is willing to service orders for a particular geographical region during this time. In this example, based on the predicted set of working hours for the picker and the set of preferences associated with the picker, the supply prediction module 224 may predict an incremental increase to the supply of pickers available to service orders for the geographical region during one or more future time periods that include the predicted set of working hours for the picker.

The supply prediction module 224 also may predict an availability of a set of pickers to service orders for one or more geographical regions during one or more future time periods. The supply prediction module 224 may do so based on a geographical region associated with a predicted set of working hours for each picker during the future time period(s). For example, suppose that for a set of pickers, the picker availability module 222 has predicted a set of working hours for each picker during a future time period and retrieves information describing a geographical region for which each picker is willing to service orders during the future time period (e.g., from a set of preferences associated with the picker stored in the data store 250). In this example, based on the predicted set of working hours for each picker and the information describing the geographical region for which each picker is willing to service orders during the future time period, the supply prediction module 224 may predict an availability of the set of pickers to service orders for the geographical region during the future time period.

In some embodiments, the supply prediction module 224 also predicts an availability of a set of pickers to service orders for one or more geographical regions during one or more future time periods based on additional types of information. These additional types of information may be retrieved from the data store 250 or any other suitable source and may include a frequency with which each picker serviced orders placed with the online concierge system 140 during a previous set of working hours for the picker, a number of orders associated with a geographical region placed with the online concierge system 140 during a previous time period, or any other suitable types of information. For example, suppose that the supply prediction module 224 has predicted an availability of a set of pickers to service orders for a geographical region during a future time period based on a predicted set of working hours for each picker and information describing a geographical region for which each picker is willing to service orders, as described above. In this example, based on picker data describing a frequency with which each picker serviced orders for the geographical region during a previous set of working hours, the supply prediction module 224 may refine this prediction to account for pickers who may not be available to service orders during the future time period because they are already busy servicing orders. In the above example, the previous set of working hours may have at least a threshold measure of similarity to the predicted set of working hours for each picker (e.g., a similar time of the day, day of the week, etc.). In this example, based on order data describing a number of orders associated with the geographical region placed with the online concierge system 140 during a previous time period, the supply prediction module 224 may further refine this prediction to account for the demand to service orders placed with the online concierge system 140. In the above example, the previous time period may have at least a threshold measure of similarity to the future time period (e.g., similar days of the week, months, etc.).

The supply prediction module 224 also may predict an availability of a set of pickers to service orders for one or more geographical regions during one or more future time periods based on one or more picker cohorts to which the supply prediction module 224 may assign each picker. As used herein, a “picker cohort” refers to one or more pickers that share one or more characteristics. In some embodiments, the supply prediction module 224 assigns a picker to one or more picker cohorts based on a predicted set of working hours for the picker during one or more future time periods. In such embodiments, a predicted set of working hours for a picker assigned to each picker cohort has at least a threshold measure of similarity to a predicted set of working hours for each additional picker assigned to the same picker cohort. For example, a predicted set of working hours for each picker assigned to a picker cohort may indicate that the picker is likely available to service orders for a particular zip code for at least four hours during a future time period (e.g., between 12:00 p.m. and 6:00 p.m. every weekday for the foreseeable future). The supply prediction module 224 also may assign a picker to one or more picker cohorts based on additional types of information, such as the picker's previous shopping history indicating whether the picker was willing to service orders that required the picker to climb stairs, carry heavy items, etc., or based on any other suitable types of information.

In some embodiments, the supply prediction module 224 uses a user embedding describing a picker to assign the picker to one or more picker cohorts. A user embedding may be generated by one or more machine learning models based on a predicted availability of a picker to service orders associated with one or more geographical regions during one or more future time periods or any other suitable types of information and may be stored in the data store 250. For example, the supply prediction module 224 may assign pickers to one or more picker cohorts by grouping user embeddings representing the pickers into one or more clusters in an embedding space using an unsupervised learning method (e.g., k-means clustering), in which each cluster corresponds to a picker cohort. In this example, a first cluster may correspond to early morning pickers who are available to service orders for a geographical region early in the morning (e.g., from 4:00 a.m. to 9:00 a.m.), while a second cluster may correspond to business hours pickers who are available to service orders for the geographical region during business hours (e.g., from 9:00 a.m. to 5:00 p.m.). In the above example, a third cluster may correspond to after-hours pickers who are available to service orders for the geographical region after normal business hours (e.g., from 5:00 p.m. to 10:00 p.m.), while a fourth cluster may correspond to late night pickers who are available to service orders for the geographical region late at night (e.g., from 10:00 p.m. to 4:00 a.m.). Continuing with this example, a fifth cluster may correspond to weekend pickers who are available to service orders for the geographical region at any time on weekends.

The incentive determination module 226 may determine an incentive associated with a picker. An incentive associated with a picker may encourage the picker to increase their availability to service orders placed with the online concierge system 140. For example, an incentive associated with a picker may correspond to a bonus, a priority to view orders associated with higher tips before other pickers, etc. that the picker may receive if the picker agrees to access information describing a set of orders placed with the online concierge system 140 available for servicing during a future time period. The incentive determination module 226 may determine an incentive associated with a picker based on predicted availabilities of one or more pickers to service orders for one or more geographical regions during one or more future time periods (e.g., based on a predicted incremental increase to the supply of pickers available to service orders for the geographical region(s) during the future time period(s)). For example, suppose that the supply prediction module 224 has predicted an availability of a set of pickers to service orders associated with a geographical region during a future time period. In this example, the incentive determination module 226 may determine an incentive associated with a picker included among the set of pickers based on a first number of pickers that are likely available to service orders for the geographical region during the future time period and a second number of pickers that are likely not available to service orders for the geographical region during the future time period. Continuing with this example, if the incentive is a bonus or a priority to view orders associated with higher tips, the bonus or priority may be inversely proportional to a ratio of the first number of pickers to the second number of pickers. Once the incentive determination module 226 has determined an incentive associated with a picker, the incentive determination module 226 may then communicate information describing the incentive to the interface module 228, as described below.

The interface module 228 may generate notifications (e.g., push or email notifications) to remind or encourage pickers to access information describing orders placed with the online concierge system 140 available for servicing. The interface module 228 may generate a notification to remind or encourage a picker to access information describing a set of orders placed with the online concierge system 140 available for servicing based on a predicted set of working hours for the picker. For example, suppose that a predicted set of working hours for a picker includes a start time of 6:00 a.m. every weekday. In this example, the interface module 228 generates a notification reminding the picker to access information describing a set of orders placed with the online concierge system 140 available for servicing so that the notification may be sent to a picker client device 110 associated with the picker at 6:00 a.m. every weekday. The interface module 228 also may generate the notification based on additional types of information, such as picker data (e.g., a geographical region or a set of preferences associated with the picker), contextual information (e.g., weather or traffic conditions) received from one or more third-party systems, or any other suitable types of information. For example, based on information describing heavy rain in a geographical region associated with a picker (e.g., received from a third-party weather application), the interface module 228 may generate a notification encouraging the picker to access information describing a set of orders placed with the online concierge system 140 available for servicing despite the heavy rain.

In embodiments in which the incentive determination module 226 determines incentives associated with pickers, the interface module 228 also generates notifications (e.g., push or email notifications) describing the incentives. The interface module 228 may generate a notification describing an incentive associated with a picker based on information describing the incentive received from the incentive determination module 226. For example, if an incentive associated with a picker corresponds to a bonus or a priority to view orders associated with higher tips before other pickers, the notification may describe the bonus (e.g., an amount of the bonus) or the priority given to the picker (e.g., a number of minutes that the picker is able to view the orders before other pickers). In some embodiments, an incentive associated with a picker may be included in a notification reminding or encouraging the picker to access information describing a set of orders placed with the online concierge system 140 available for servicing.

Once the interface module 228 generates a notification for a picker, the interface module 228 may send the notification for display to a picker client device 110 associated with the picker. For example, suppose that the interface module 228 has generated a notification encouraging a picker to access information describing a set of orders placed with the online concierge system 140 available for servicing and that a predicted set of working hours for the picker includes a start time of 7:00 a.m. every weekday. In this example, the interface module 228 may send the notification to a picker client device 110 associated with the picker at 7:00 a.m. every weekday. The interface module 228 may send a notification for display to a picker client device 110 associated with a picker based on picker data associated with the picker. In the above example, the interface module 228 may send the notification in a manner described by a set of preferences specified by the picker stored in the data store 250 describing how the picker would like to receive such notifications (e.g., as push notifications). Furthermore, in the above example, if the interface module 228 has received information describing an incentive associated with the picker, the information describing the incentive also may be included in the same notification or in a separate notification generated and sent for display to the picker client device 110 by the interface module 228.

The order management module 230 manages orders for items from customers. The order management module 230 receives orders from customer client devices 100 and assigns the orders to pickers for service based on picker data. For example, the order management module 230 assigns an order to a picker based on the picker's location and the retailer location from which the ordered items are to be collected. The order management module 230 may also assign an order to a picker based on how many items are in the order, a vehicle operated by the picker, the delivery location, the picker's preferences for how far to travel to deliver an order, the picker's ratings by customers, or how often a picker agrees to service an order.

In some embodiments, the order management module 230 determines when to assign an order to a picker based on a delivery timeframe requested by the customer who placed the order. The order management module 230 computes an estimated amount of time that it would take for a picker to collect the items for an order and deliver the ordered items to the delivery location for the order. The order management module 230 assigns the order to a picker at a time such that, if the picker immediately services the order, the picker is likely to deliver the order at a time within the timeframe. Thus, when the order management module 230 receives an order, the order management module 230 may delay in assigning the order to a picker if the timeframe is far enough in the future.

When the order management module 230 assigns an order to a picker, the order management module 230 transmits the order to the picker client device 110 associated with the picker. The order management module 230 may also transmit navigation instructions from the picker's current location to the retailer location associated with the order. If the order includes items to collect from multiple retailer locations, the order management module 230 identifies the retailer locations to the picker and may also specify a sequence in which the picker should visit the retailer locations.

The order management module 230 may track the location of the picker through the picker client device 110 to determine when the picker arrives at the retailer location. When the picker arrives at the retailer location, the order management module 230 transmits the order to the picker client device 110 for display to the picker. As the picker uses the picker client device 110 to collect items at the retailer location, the order management module 230 receives item identifiers for items that the picker has collected for the order. In some embodiments, the order management module 230 receives images of items from the picker client device 110 and applies computer vision techniques to the images to identify the items depicted by the images. The order management module 230 may track the progress of the picker as the picker collects items for an order and may transmit progress updates to the customer client device 100 that describe which items have been collected for the customer's order.

In some embodiments, the order management module 230 tracks the location of the picker within the retailer location. The order management module 230 uses sensor data from the picker client device 110 or from sensors in the retailer location to determine the location of the picker in the retailer location. The order management module 230 may transmit instructions to the picker client device 110 to display a map of the retailer location indicating where in the retailer location the picker is located. Additionally, the order management module 230 may instruct the picker client device 110 to display the locations of items for the picker to collect, and may further display navigation instructions for how the picker can travel from their current location to the location of a next item to collect for an order.

The order management module 230 determines when the picker has collected all of the items for an order. For example, the order management module 230 may receive a message from the picker client device 110 indicating that all of the items for an order have been collected. Alternatively, the order management module 230 may receive item identifiers for items collected by the picker and determine when all of the items in an order have been collected. When the order management module 230 determines that the picker has completed an order, the order management module 230 transmits the delivery location for the order to the picker client device 110. The order management module 230 may also transmit navigation instructions to the picker client device 110 that specify how to travel from the retailer location to the delivery location, or to a subsequent retailer location for further item collection. The order management module 230 tracks the location of the picker as the picker travels to the delivery location for an order, and updates the customer with the location of the picker so that the customer can track the progress of their order. In some embodiments, the order management module 230 computes an estimated time of arrival for the picker at the delivery location and provides the estimated time of arrival to the customer.

In some embodiments, the order management module 230 facilitates communication between the customer client device 100 and the picker client device 110. As noted above, a customer may use a customer client device 100 to send a message to the picker client device 110. The order management module 230 receives the message from the customer client device 100 and transmits the message to the picker client device 110 for presentation to the picker. The picker may use the picker client device 110 to send a message to the customer client device 100 in a similar manner.

The order management module 230 coordinates payment by the customer for the order. The order management module 230 uses payment information provided by the customer (e.g., a credit card number or a bank account) to receive payment for the order. In some embodiments, the order management module 230 stores the payment information for use in subsequent orders by the customer. The order management module 230 computes a total cost for the order and charges the customer that cost. The order management module 230 may provide a portion of the total cost to the picker for servicing the order, and another portion of the total cost to the retailer.

The machine learning training module 240 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model is used by the machine learning model to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 240 generates the set of parameters for a machine learning model by “training” the machine learning model. Once trained, the machine learning model uses the set of parameters to transform inputs into outputs.

The machine learning training module 240 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

In embodiments in which the picker availability module 222 accesses the picker availability model that is trained to predict a set of working hours for a picker during one or more future time periods, the machine learning training module 240 may train the picker availability model. The machine learning training module 240 may train the picker availability model via supervised learning (e.g., linear regression) based on historical working hours data associated with a picker or any other suitable types of information. For example, the machine learning training module 240 may train the picker availability model via supervised learning based on historical working hours data associated with a picker describing one or more previous sets of working hours for the picker. In some embodiments, the machine learning training module 240 may retrain the picker availability model based on information describing an actual set of working hours for a picker. For example, suppose that once the machine learning training module 240 trains the picker availability model, the picker availability module 222 accesses and applies the picker availability model to predict a set of working hours for a picker during one or more future time periods. In this example, based on information describing an actual set of working hours for the picker during these time period(s) collected by the data collection module 200 and stored in the data store 250, the machine learning training module 240 may retrain the picker availability model.

To illustrate an example of how the picker availability model may be trained, suppose that the machine learning training module 240 receives a set of training examples. In this example, the set of training examples may include attributes of one or more previous time periods, such as a set of contextual features associated with each previous time period. In the above example, the set of contextual features may include weather conditions (e.g., heavy rain or snow), seasonality (e.g., a set of times of the day, days of the week, months, holidays, seasons, etc.), traffic conditions (e.g., heavy or light traffic, road closures, detours, etc.), or any other suitable types of contextual features associated with a geographical region for which a picker was willing to service orders. Continuing with this example, the attributes of the previous time period(s) also may include one or more states of the picker, which may indicate whether the picker was looking for or available for work, working (e.g., collecting items included in an order, driving to a retailer location or a delivery location, or delivering an order), offline or not available for work, etc. In the above example, the machine learning training module 240 also may receive labels which represent expected outputs of the picker availability model, in which a label describes a previous set of working hours for the picker during each previous time period. In this example, the label may include a start time and/or an end time associated with the previous set of working hours for the picker (e.g., when a state of the picker indicated that the picker was looking for work, available for work, or working). In the above example, the label also or alternatively may include one or more values indicating whether there were any working hours for the picker during each previous time period (e.g., null or 0 for no working hours or 1 for at least some working hours). Continuing with this example, the machine learning training module 240 may then train the picker availability model based on the attributes, as well as the labels by comparing its output from input data of each training example to the label for the training example.

The machine learning training module 240 may apply an iterative process to train a machine learning model whereby the machine learning training module 240 trains the machine learning model on each of the set of training examples. To train a machine learning model based on a training example, the machine learning training module 240 applies the machine learning model to the input data in the training example to generate an output. The machine learning training module 240 scores the output from the machine learning model using a loss function. A loss function is a function that generates a score for the output of the machine learning model such that the score is higher when the machine learning model performs poorly and lower when the machine learning model performs well. In situations in which the training example includes a label, the loss function is also based on the label for the training example. Some example loss functions include the mean square error function, the mean absolute error, the hinge loss function, and the cross-entropy loss function. The machine learning training module 240 updates the set of parameters for the machine learning model based on the score generated by the loss function. For example, the machine learning training module 240 may apply gradient descent to update the set of parameters.

The data store 250 stores data used by the online concierge system 140. For example, the data store 250 stores customer data, item data, order data, and picker data for use by the online concierge system 140. The data store 250 also stores trained machine learning models trained by the machine learning training module 240. For example, the data store 250 may store the set of parameters for a trained machine learning model on one or more non-transitory, computer-readable media. The data store 250 uses computer-readable media to store data, and may use databases to organize the stored data.

### Predicting Working Hours for Pickers of an Online Concierge System

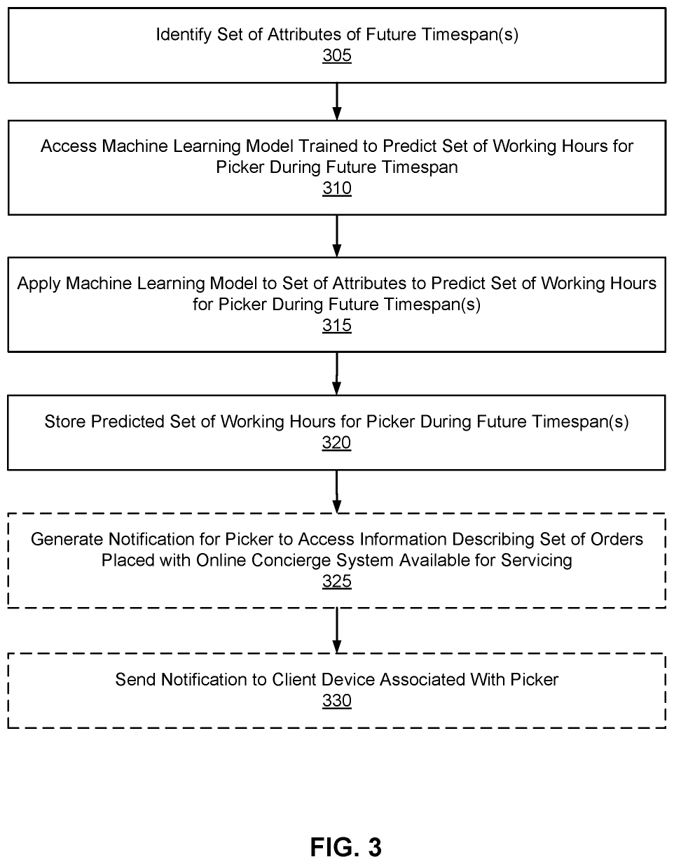

FIG. 3 is a flowchart of a method for predicting a set of working hours for a picker of an online concierge system 140, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system 140 without human intervention.

The online concierge system 140 identifies 305 (e.g., using the picker availability module 222) a set of attributes of one or more future time periods. Attributes of a future time period may include contextual features associated with the future time period and a geographical region, such as weather conditions (e.g., heavy rain or snow), seasonality (e.g., a set of times of the day, days of the week, months, holidays, seasons, etc.), traffic conditions (e.g., heavy or light traffic, road closures, detours, etc.), or any other suitable types of contextual information. A geographical region associated with a future time period may be associated with a picker (e.g., a geographical region for which the picker is willing to service orders during the future time period). The online concierge system 140 may identify 305 the set of attributes of the future time period(s) based on information received from one or more third-party systems (e.g., third-party weather, traffic, or calendar applications or websites), picker data associated with the picker (e.g., received from a picker client device 110 associated with the picker or retrieved from the data store 250), or any other suitable types of information. For example, based on information received from the picker client device 110 describing a time zone associated with the picker and information received from a calendar application describing a future time period corresponding to the next seven days, the online concierge system 140 may identify (step 305) attributes of the future time period, including days of the week, one or more months, any holidays, etc. included in the future time period. In the above example, suppose that the online concierge system 140 retrieves information (e.g., from the data store 250) describing a geographical region for which the picker is willing to service orders during the future time period and also receives information describing a weather forecast and traffic conditions for the geographical region during the future time period from one or more third-party systems (e.g., weather and traffic websites). In this example, based on the information received from the third-party system(s), attributes of the future time period identified 305 by the online concierge system 140 also may include projected weather and traffic conditions associated with each day of the future time period for the geographical region.

The online concierge system 140 may predict (e.g., using the picker availability module 222) a set of working hours for the picker during the future time period(s). The set of working hours for the picker describes an availability of the picker to service orders placed with the online concierge system 140 and includes a set of times (e.g., minutes, hours, etc.) during which the picker is available to service the orders. Furthermore, the set of working hours may be described by a start time, an end time, or a state associated with the picker (e.g., indicating that the picker is looking for work). The online concierge system 140 may predict the set of working hours for the picker during the future time period(s) based on historical working hours data associated with the picker (e.g., retrieved by the picker availability module 222 from the data store 250) or based on any other suitable types of information. The historical working hours data may describe one or more previous sets of working hours for the picker, in which a previous set of working hours includes a set of times during which the picker was available to service orders placed with the online concierge system 140, regardless of whether the picker actually serviced any orders. For example, suppose that the historical working hours data associated with the picker includes a start time and an end time associated with a previous set of working hours for the picker. In this example, if the start time and the end time are 9:00 a.m. and 5:00 p.m., respectively, for every weekday for the previous two months, based on the historical working hours data associated with the picker, the online concierge system 140 may predict the set of working hours for the picker during the next week corresponding to 9:00 a.m. to 5:00 p.m. every weekday. In some embodiments, the online concierge system 140 only predicts a start time associated with the set of working hours for the picker during the future time period(s), which may correspond to a time at which a notification is sent to a picker client device 110 associated with the picker, as further described below. The predicted set of working hours also may be associated with a value (e.g., a score or percentage) indicating a predicted likelihood that the picker will be available to service orders placed with the online concierge system 140 during the corresponding set of hours.

In some embodiments, the online concierge system 140 predicts the set of working hours for the picker during the future time period(s) using a picker availability model, which is a machine learning model trained to predict the set of working hours for the picker. For example, the picker availability model may be a linear regression model that is specific to the picker. To use the picker availability model, the online concierge system 140 accesses 310 (e.g., using the picker availability module 222) the model (e.g., from the data store 250) and applies 315 (e.g., using the picker availability module 222) the model to a set of inputs, which may include the set of attributes of the future time period(s). The online concierge system 140 then receives (e.g., via the picker availability module 222) an output from the picker availability model describing the predicted set of working hours for the picker during the future time period(s). For example, the online concierge system 140 may provide the set of inputs to the picker availability model including the set of attributes of the future time period(s) (e.g., holidays, days of the week, projected weather or traffic conditions, etc.) and receive an output from the model describing the predicted set of working hours for the picker during the future time period(s). In this example, the predicted set of working hours may be described by a start time (e.g., 10:00 p.m. on Aug. 10, 2023) and an end time (e.g., 2:00 a.m. on Aug. 11, 2023). In embodiments in which the online concierge system 140 only predicts the start time associated with the set of working hours for the picker during the future time period(s), as described above, the output of the picker availability model may only include the start time. The output of the picker availability model also may include additional types of information, such as a value indicating a predicted likelihood that the picker will be available to service orders placed with the online concierge system 140 during the predicted set of working hours, one or more values indicating whether there are any working hours predicted for the picker during the future time period(s), etc. For example, the output may include a value of null or 0 if there are no working hours during the future time period(s) or a value of 1 if there are at least some working hours during the future time period(s).

In various embodiments, the picker availability model is trained by the online concierge system 140 (e.g., using the machine learning training module 240). The online concierge system 140 may train the picker availability model via supervised learning (e.g., linear regression) based on the historical working hours data associated with the picker or any other suitable types of information. For example, the online concierge system 140 may train the picker availability model via supervised learning based on historical working hours data associated with the picker describing one or more previous sets of working hours for the picker. In some embodiments, the online concierge system 140 may retrain (e.g., using the machine learning training module 240) the picker availability model based on information describing an actual set of working hours for the picker. For example, suppose that the online concierge system 140 has trained the picker availability model and has also accessed 310 and applied 315 the picker availability model to predict the set of working hours for the picker during the future time period(s). In this example, based on information describing an actual set of working hours for the picker during these time period(s) collected by the online concierge system 140 (e.g., by the data collection module 200) and stored (e.g., in the data store 250), the online concierge system 140 may retrain the picker availability model.

To illustrate an example of how the picker availability model may be trained, suppose that the online concierge system 140 receives a set of training examples. In this example, the set of training examples may include attributes of one or more previous time periods, such as a set of contextual features associated with each previous time period. In the above example, the set of contextual features may include weather conditions (e.g., heavy rain or snow), seasonality (e.g., a set of times of the day, days of the week, months, holidays, seasons, etc.), traffic conditions (e.g., heavy or light traffic, road closures, detours, etc.), or any other suitable types of contextual features associated with a geographical region for which the picker was willing to service orders. Continuing with this example, the attributes of the previous time period(s) also may include one or more states of the picker, which may indicate whether the picker was looking for or available for work, working (e.g., collecting items included in an order, driving to a retailer location or a delivery location, or delivering an order), offline or not available for work, etc. In the above example, the online concierge system 140 also may receive labels which represent expected outputs of the picker availability model, in which a label describes a previous set of working hours for the picker during each previous time period. In this example, the label may include a start time and/or an end time associated with the previous set of working hours for the picker (e.g., when a state of the picker indicated that the picker was looking for work, available for work, or working). In the above example, the label also or alternatively may include one or more values indicating whether there were any working hours for the picker during each previous time period (e.g., null or 0 for no working hours or 1 for at least some working hours). Continuing with this example, the online concierge system 140 may then train the picker availability model based on the attributes, as well as the labels by comparing its output from input data of each training example to the label for the training example.

Once the online concierge system 140 predicts the set of working hours for the picker during the future time period(s), information describing the predicted set of working hours may be stored 320 (e.g., by the picker availability module 222 in the data store 250) in association with picker data for the picker (e.g., as a schedule associated with the picker). The predicted set of working hours for the picker during the future time period(s) also may be associated with one or more geographical regions for which the picker is willing to service orders during the future time period(s) or any other suitable types of information. For example, the predicted set of working hours for the picker may indicate that the picker is likely to be available to service orders placed with the online concierge system 140 on weekdays between 9:00 a.m. and 12:00 p.m. in one geographical region and on weekends between 10:00 a.m. and 2:00 p.m. in another geographical region.

The online concierge system 140 also may determine (e.g., using the incentive determination module 226) an incentive associated with the picker. The incentive associated with the picker may encourage the picker to increase their availability to service orders placed with the online concierge system 140. For example, the incentive associated with the picker may correspond to a bonus, a priority to view orders associated with higher tips before other pickers, etc. that the picker may receive if the picker agrees to access information describing a set of orders placed with the online concierge system 140 available for servicing during a future time period. The online concierge system 140 may determine the incentive associated with the picker based on a predicted availability of a set of pickers to service orders for one or more geographical regions during the future time period(s) (e.g., based on a predicted incremental increase to the supply of pickers available to service orders for the geographical region(s) during the future time period(s)), as described below. For example, suppose that the picker is included among a set of pickers and that the online concierge system 140 has predicted an availability of the set of pickers to service orders associated with a geographical region during the future time period(s). In this example, the online concierge system 140 may determine the incentive associated with the picker based on a first number of pickers that are likely available to service orders for the geographical region during the future time period and a second number of pickers that are likely not available to service orders for the geographical region during the future time period. Continuing with this example, if the incentive is a bonus or a priority to view orders associated with higher tips, the bonus or priority may be inversely proportional to a ratio of the first number of pickers to the second number of pickers.

The online concierge system 140 may then generate 325 (e.g., using the interface module 228) a notification (e.g., a push or email notification) to remind or encourage the picker to access information describing a set of orders placed with the online concierge system 140 available for servicing. The online concierge system 140 may generate 325 the notification based on the predicted set of working hours for the picker. For example, suppose that the predicted set of working hours for the picker includes a start time of 6:00 a.m. every weekday. In this example, the online concierge system 140 generates 325 the notification reminding the picker to access information describing a set of orders placed with the online concierge system 140 available for servicing so that the notification may be sent to a picker client device 110 associated with the picker at 6:00 a.m. every weekday. The online concierge system 140 also may generate 325 the notification based on additional types of information, such as picker data (e.g., a geographical region or a set of preferences associated with the picker), contextual information (e.g., weather or traffic conditions) received from one or more third-party systems, or any other suitable types of information. For example, based on information describing heavy rain in a geographical region associated with the picker (e.g., received from a third-party weather application), the online concierge system 140 may generate 325 the notification encouraging the picker to access information describing a set of orders placed with the online concierge system 140 available for servicing despite the heavy rain.

In embodiments in which the online concierge system 140 determines an incentive associated with the picker, the online concierge system 140 also may generate (e.g., using the interface module 228) a notification (e.g., a push or email notification) describing the incentive. The online concierge system 140 may generate the notification describing the incentive associated with the picker based on information describing the incentive. For example, if the incentive associated with the picker corresponds to a bonus or a priority to view orders associated with higher tips before other pickers, the notification may describe the bonus (e.g., an amount of the bonus) or the priority given to the picker (e.g., a number of minutes that the picker is able to view the orders before other pickers). In some embodiments, the incentive associated with the picker may be included in the notification reminding or encouraging the picker to access information describing a set of orders placed with the online concierge system 140 available for servicing.

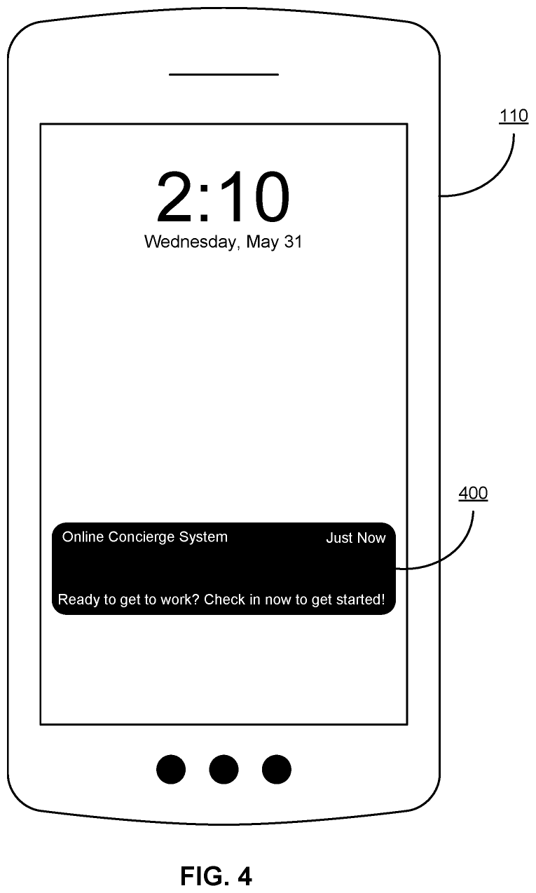

Once the online concierge system 140 generates (e.g., in step 325) a notification for the picker, the online concierge system 140 may send 330 (e.g., using the interface module 228) the notification for display to the picker client device 110 associated with the picker. For example, suppose that the online concierge system 140 has generated 325 a notification encouraging the picker to access information describing a set of orders placed with the online concierge system 140 available for servicing and that a predicted set of working hours for the picker includes a start time of 2:10 p.m. every weekday. As shown in FIG. 4, which is an example of a notification 400 for a picker to access an online concierge system 140 to view information describing a set of orders available for servicing, in accordance with one or more embodiments, the online concierge system 140 may send 330 the notification 400 to the picker client device 110 associated with the picker at 2:10 p.m. every weekday. The online concierge system 140 may send 330 a notification 400 for display to the picker client device 110 associated with the picker based on picker data associated with the picker. In the above example, the online concierge system 140 may send 330 the notification 400 in a manner described by a set of preferences specified by the picker (e.g., stored in the data store 250) indicating that the picker would like to receive such notifications 400 as push notifications 400. Furthermore, in the above example, if the online concierge system 140 determines an incentive associated with the picker, information describing the incentive also may be included in the same or a separate notification 400.

The online concierge system 140 also may predict (e.g., using the supply prediction module 224) an incremental increase to the supply of pickers available to service orders for one or more geographical regions during the future time period(s). The online concierge system 140 may do so based on the predicted set of working hours for the picker and information describing a geographical region for which the picker is willing to service orders during the future time period(s). For example, suppose that the predicted set of working hours for the picker is between 4:00 p.m. and 9:00 p.m. on a particular date in the future and that a set of preferences associated with the picker indicates that the picker is willing to service orders for a particular geographical region during this time. In this example, based on the predicted set of working hours for the picker and the set of preferences associated with the picker, the online concierge system 140 may predict an incremental increase to the supply of pickers available to service orders for the geographical region during the future time period(s) that include the predicted set of working hours for the picker.

In some embodiments, the online concierge system 140 also predicts (e.g., using the supply prediction module 224) an availability of a set of pickers to service orders for the geographical region(s) during the future time period(s). In such embodiments, the set of pickers includes the picker for which the online concierge system 140 has predicted the set of working hours during the future time period(s) and the online concierge system 140 makes the prediction based on a geographical region associated with the predicted set of working hours for the picker during the future time period(s). For example, suppose that for the set of pickers, the online concierge system 140 has predicted the set of working hours for each picker during the future time period(s) and retrieves information describing a geographical region for which each picker is willing to service orders during the future time period(s) (e.g., from a set of preferences associated with the picker stored in the data store 250). In this example, based on the predicted set of working hours for each picker and the information describing the geographical region for which each picker is willing to service orders during the future time period(s), the online concierge system 140 may predict the availability of the set of pickers to service orders for the geographical region during the future time period(s).

In some embodiments, the online concierge system 140 also predicts the availability of the set of pickers to service orders for the geographical region(s) during the future time period(s) based on additional types of information, which the online concierge system 140 may retrieve (e.g., from the data store 250 or any other suitable source). Examples of such types of information include: a frequency with which each picker serviced orders placed with the online concierge system 140 during a previous set of working hours for the picker, a number of orders associated with a geographical region placed with the online concierge system 140 during a previous time period, or any other suitable types of information. For example, suppose that the online concierge system 140 has predicted the availability of the set of pickers to service orders for the geographical region during the future time period(s) based on the predicted set of working hours for each picker and the information describing the geographical region for which each picker is willing to service orders, as described above. In this example, based on picker data describing a frequency with which each picker serviced orders for the geographical region during a previous set of working hours, the online concierge system 140 may refine this prediction to account for pickers who may not be available to service orders during the future time period(s) because they are already busy servicing orders. In the above example, the previous set of working hours may have at least a threshold measure of similarity to the predicted set of working hours for each picker (e.g., a similar time of the day, day of the week, etc.). In this example, based on order data describing a number of orders associated with the geographical region placed with the online concierge system 140 during a previous time period, the online concierge system 140 may further refine this prediction to account for the demand to service orders placed with the online concierge system 140. In the above example, the previous time period may have at least a threshold measure of similarity to the future time period(s) (e.g., similar days of the week, months, etc.).

The online concierge system 140 also may predict the availability of the set of pickers to service orders for the geographical region(s) during the future time period(s) based on one or more picker cohorts to which the online concierge system 140 may assign (e.g., using the supply prediction module 224) each picker. As described above, a “picker cohort” refers to one or more pickers that share one or more characteristics. In some embodiments, the online concierge system 140 assigns a picker to one or more picker cohorts based on a predicted set of working hours for the picker during one or more future time periods. In such embodiments, a predicted set of working hours for a picker assigned to each picker cohort has at least a threshold measure of similarity to a predicted set of working hours for each additional picker assigned to the same picker cohort. For example, a predicted set of working hours for each picker assigned to a picker cohort may indicate that the picker is likely available to service orders for a particular zip code for at least four hours during a future time period (e.g., between 12:00 p.m. and 6:00 p.m. every weekday for the foreseeable future). The online concierge system 140 also may assign a picker to one or more picker cohorts based on additional types of information, such as the picker's previous shopping history indicating whether the picker was willing to service orders that required the picker to climb stairs, carry heavy items, etc., or based on any other suitable types of information.

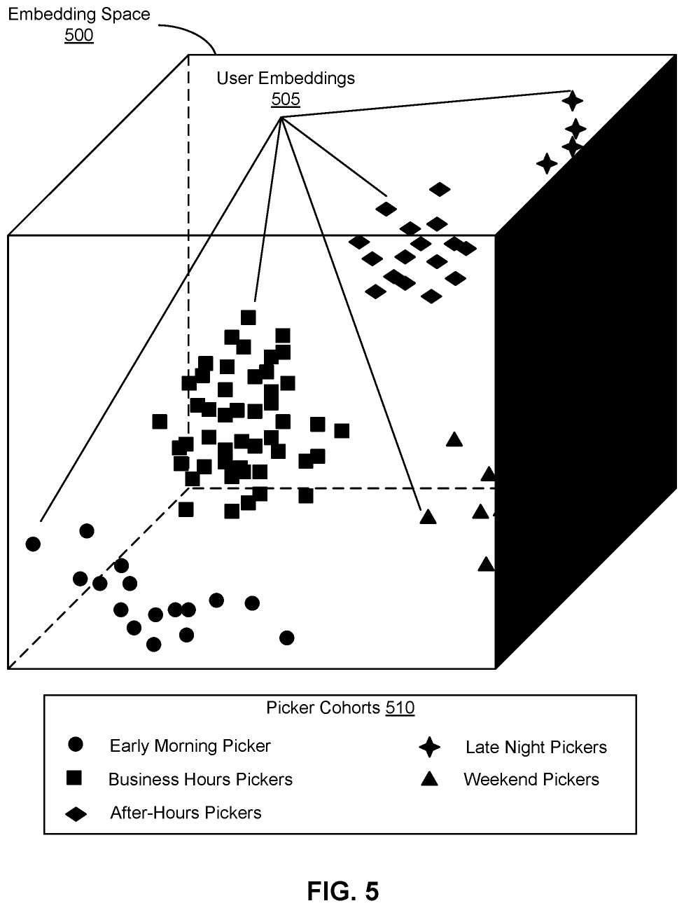

In some embodiments, the online concierge system 140 uses a user embedding describing a picker to assign the picker to one or more picker cohorts. A user embedding may be generated by one or more machine learning models based on a predicted availability of a picker to service orders associated with one or more geographical regions during one or more future time periods or any other suitable types of information and may be stored (e.g., in the data store 250). For example, as shown in FIG. 5, which illustrates examples of picker cohorts 510, in accordance with one or more embodiments, the online concierge system 140 may assign pickers to one or more picker cohorts 510 by grouping user embeddings 505 representing the pickers into one or more clusters in an embedding space 500 using an unsupervised learning method (e.g., k-means clustering), in which each cluster corresponds to a picker cohort 510. In this example, a first cluster may correspond to early morning pickers who are available to service orders for a geographical region early in the morning (e.g., from 4:00 a.m. to 9:00 a.m.), while a second cluster may correspond to business hours pickers who are available to service orders for the geographical region during business hours (e.g., from 9:00 a.m. to 5:00 p.m.). In the above example, a third cluster may correspond to after-hours pickers who are available to service orders for the geographical region after normal business hours (e.g., from 5:00 p.m. to 10:00 p.m.), while a fourth cluster may correspond to late night pickers who are available to service orders for the geographical region late at night (e.g., from 10:00 p.m. to 4:00 a.m.). Continuing with this example, a fifth cluster may correspond to weekend pickers who are available to service orders for the geographical region at any time on weekends.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
identifying, at an online concierge system, a set of attributes of one or more future time periods;
accessing a machine learning model trained to predict a set of working hours for a picker during a future time period, the set of working hours describing an availability of the picker to service orders placed with the online concierge system, wherein the machine learning model is trained by:
receiving historical working hours data associated with the picker, and
training the machine learning model based at least in part on the historical working hours data;
applying the machine learning model to the set of attributes of the one or more future time periods to predict the set of working hours for the picker during the one or more future time periods; and
storing the predicted set of working hours for the picker during the one or more future time periods.

2. The method of claim 1, further comprising:
generating a notification for the picker to access information describing a set of orders placed with the online concierge system available for servicing based at least in part on the predicted set of working hours for the picker during the one or more future time periods; and
sending the notification to a client device associated with the picker.

3. The method of claim 1, further comprising:
retrieving information describing a geographical region associated with the availability of the picker to service orders placed with the online concierge system; and
predicting an additional availability of a set of pickers to service orders associated with the geographical region during the one or more future time periods based at least in part on the predicted set of working hours for the picker during the one or more future time periods.

4. The method of claim 3, wherein predicting the additional availability of the set of pickers to service orders associated with the geographical region during the one or more future time periods comprises:
retrieving information describing a frequency with which the picker serviced orders associated with the geographical region during a previous set of working hours for the picker; and
predicting the additional availability of the set of pickers to service orders associated with the geographical region during the one or more future time periods based at least in part on the frequency with which the picker serviced orders placed with the online concierge system during the previous set of working hours for the picker.

5. The method of claim 1, further comprising:
determining an incentive associated with the picker based at least in part on the predicted set of working hours for the picker during the one or more future time periods;
generating a notification describing the incentive; and
sending the notification to a client device associated with the picker.

6. The method of claim 1, further comprising:
assigning the picker to a picker cohort of a plurality of picker cohorts based at least in part on the predicted set of working hours for the picker during the one or more future time periods, wherein the predicted set of working hours for the picker has at least a threshold measure of similarity to one or more predicted sets of working hours for one or more additional pickers assigned to the picker cohort.

7. The method of claim 1, wherein receiving the historical working hours data associated with the picker comprise receiving one or more of: a start time associated with a previous set of working hours for the picker, an end time associated with a previous set of working hours for the picker, a state of the picker associated with a previous set of working hours for the picker, a geographical region associated with a previous set of working hours for the picker, or a set of contextual features associated with a previous set of working hours for the picker.

8. The method of claim 7, wherein the start time associated with a previous set of working hours for the picker comprises an earliest time of a day that a request to access information describing a set of orders placed with the online concierge system available for servicing is received from a client device associated with the picker and the end time associated with a previous set of working hours for the picker comprises a latest time of a day that a request to access information describing a set of orders placed with the online concierge system available for servicing is received from the client device associated with the picker.

9. The method of claim 1, wherein predicting the set of working hours for the picker during the one or more future time periods comprises predicting one or more of: a start time associated with the predicted set of working hours, an end time associated with the predicted set of working hours, or a predicted likelihood that the picker will be available to service orders placed with the online concierge system during the predicted set of working hours.

10. The method of claim 1, further comprising:
receiving information describing an actual set of working hours for the picker during the one or more future time periods; and
retraining the machine learning model based at least in part on the information describing the actual set of working hours for the picker during the one or more future time periods, wherein the machine learning model comprises a linear regression model.

11. A computer program product comprising a non-transitory computer-readable storage medium having instructions encoded thereon that, when executed by a processor, cause the processor to perform steps comprising:
identifying, at an online concierge system, a set of attributes of one or more future time periods;
accessing a machine learning model trained to predict a set of working hours for a picker during a future time period, the set of working hours describing an availability of the picker to service orders placed with the online concierge system, wherein the machine learning model is trained by:
receiving historical working hours data associated with the picker, and
training the machine learning model based at least in part on the historical working hours data;
applying the machine learning model to the set of attributes of the one or more future time periods to predict the set of working hours for the picker during the one or more future time periods; and
storing the predicted set of working hours for the picker during the one or more future time periods.

12. The computer program product of claim 11, wherein the computer-readable storage medium further has instructions encoded thereon that, when executed by the processor, cause the processor to perform steps comprising:
generating a notification for the picker to access information describing a set of orders placed with the online concierge system available for servicing based at least in part on the predicted set of working hours for the picker during the one or more future time periods; and
sending the notification to a client device associated with the picker.

13. The computer program product of claim 11, wherein the computer-readable storage medium further has instructions encoded thereon that, when executed by the processor, cause the processor to perform steps comprising:
retrieving information describing a geographical region associated with the availability of the picker to service orders placed with the online concierge system; and
predicting an additional availability of a set of pickers to service orders associated with the geographical region during the one or more future time periods based at least in part on the predicted set of working hours for the picker during the one or more future time periods.

14. The computer program product of claim 13, wherein predicting the additional availability of the set of pickers to service orders associated with the geographical region during the one or more future time periods comprises:
retrieving information describing a frequency with which the picker serviced orders associated with the geographical region during a previous set of working hours for the picker; and
predicting the additional availability of the set of pickers to service orders associated with the geographical region during the one or more future time periods based at least in part on the frequency with which the picker serviced orders placed with the online concierge system during the previous set of working hours for the picker.

15. The computer program product of claim 11, wherein the computer-readable storage medium further has instructions encoded thereon that, when executed by the processor, cause the processor to perform steps comprising:
determining an incentive associated with the picker based at least in part on the predicted set of working hours for the picker during the one or more future time periods;
generating a notification describing the incentive; and
sending the notification to a client device associated with the picker.

16. The computer program product of claim 11, wherein the computer-readable storage medium further has instructions encoded thereon that, when executed by the processor, cause the processor to perform steps comprising:
assigning the picker to a picker cohort of a plurality of picker cohorts based at least in part on the predicted set of working hours for the picker during the one or more future time periods, wherein the predicted set of working hours for the picker has at least a threshold measure of similarity to one or more predicted sets of working hours for one or more additional pickers assigned to the picker cohort.

17. The computer program product of claim 11, wherein receiving the historical working hours data associated with the picker comprise receiving one or more of: a start time associated with a previous set of working hours for the picker, an end time associated with a previous set of working hours for the picker, a state of the picker associated with a previous set of working hours for the picker, a geographical region associated with a previous set of working hours for the picker, or a set of contextual features associated with a previous set of working hours for the picker.

18. The computer program product of claim 17, wherein the start time associated with a previous set of working hours for the picker comprises an earliest time of a day that a request to access information describing a set of orders placed with the online concierge system available for servicing is received from a client device associated with the picker and the end time associated with a previous set of working hours for the picker comprises a latest time of a day that a request to access information describing a set of orders placed with the online concierge system available for servicing is received from the client device associated with the picker.

19. The computer program product of claim 11, wherein predicting the set of working hours for the picker during the one or more future time periods comprises predicting one or more of: a start time associated with the predicted set of working hours, an end time associated with the predicted set of working hours, or a predicted likelihood that the picker will be available to service orders placed with the online concierge system during the predicted set of working hours.

20. A computer system comprising:
a processor; and
a non-transitory computer-readable storage medium storing instructions that, when executed by the processor, perform actions comprising:
identifying, at an online concierge system, a set of attributes of one or more future time periods;
accessing a machine learning model trained to predict a set of working hours for a picker during a future time period, the set of working hours describing an availability of the picker to service orders placed with the online concierge system, wherein the machine learning model is trained by:
receiving historical working hours data associated with the picker, and
training the machine learning model based at least in part on the historical working hours data;
applying the machine learning model to the set of attributes of the one or more future time periods to predict the set of working hours for the picker during the one or more future time periods; and
storing the predicted set of working hours for the picker during the one or more future time periods.
